(19) United States
(12) Patent Application Publication
(10) Pub. No.: US 2006/0176150 A1
(43) Pub. Date: Aug. 10, 2006

(54) Method at loading and unloading aircrafts

(76) Inventor: Magnus Rehn, Bromma (SE)

Correspondence Address: ALFRED J MANGELS, 4729 CORNELL ROAD, CINCINNATI, OH, 452412433, US

(21) Appl. No.: 10/545,822

(22) PCT Filed: Jan. 26, 2004
(86) PCT No.: PCT/SE04/00092

§ 371 Date: Dec. 24, 2005

(30) Foreign Application Priority Data
Feb. 18, 2003 (SE) 0300437-1

(51) Int. Cl. G05B 19/00

(52) U.S. Cl. 340/5.81; 340/572.1

(57) ABSTRACT

A method for loading goods and passengers into an aircraft, in which every passenger is identified. Goods including at least each piece of luggage that belongs to a passenger is equipped with a transponder in which information bound associated with the identity of the passenger and, possibly, the destination of the luggage is stored. A first communicator at the luggage door of the aircraft reads the transponder on the luggage that is loaded into the aircraft. A second communicator at the passenger embarkation gate reads the transponder on the carry-on luggage in association with an electronic scanning of the passenger's ticket for boarding the aircraft. The information read from each transponder is stored in a central database together with the information from the scanned ticket, and is compared by a computer connected to the central database. In the case of a discrepancy in the information, an alarm is given.

The present invention concerns a method for loading and unloading aeroplanes.

The method is aimed at increasing security, creating traceability, making possible the verification of and obtaining documentation concerning the loading and unloading of aeroplanes.

There has been a great need for increasing the security at airports ever since the terrorist attacks against the World Trade Center on 11 Sep. 2001. Many initiatives have been taken using different means in order to increase protection against attacks and against terrorist deeds. These have principally been directed at preventing attacks against aeroplanes in the air. This has meant that passengers have been checked more rigorously, that luggage has been examined using X-rays and that personnel at airports have been checked during passage to and from the outward-bound regions of the airport. Attempts have been made to couple passengers and their luggage to particular departures and in the event of a passenger choosing not to board an aeroplane, this leads to the luggage of this passenger being unloaded.

Airports have been equipped during recent years with check-in machines, and the use of boarding-card machines during embarkation is very well established. This has also been supplemented with what are known as “e-tickets”, where the air ticket is registered against a selected credit card and information is stored in databases to be presented once a passenger uses the credit card.

Various concepts have been presented as a new aspect in order to make use of biometric identification in order to verify that it is the correct person who has the right to board a certain aeroplane. This may be with the aid of finger-print recognition, retina scanning, or facial recognition. The aim is to exploit unique individual properties in order to avoid the risk that cards may be forged, exchanged or copied.

The examinations that have been relatively extensive for a long period have been investigation of carry-on luggage. The contents have been examined using X-ray equipment and, where necessary, bags have been opened for a more detailed examination.

It has become clear that checked-in luggage contained a time-bomb, in the Lockerbee accident in Scotland, in which a Pan Am aeroplane crashed following an explosion in the air. The examination and registration of luggage that is currently carried out mainly satisfies two needs: not only does it make possible the transport of luggage to the correct destination, it also makes it possible to investigate that luggage does not contain any dangerous objects at all.

There are many inadequacies, in spite of all the examinations. One such inadequacy is that handling luggage that has already been checked in and other goods that are to be loaded onto the aeroplane may be carried out in a faulty manner such that goods that are not to be carried are erroneously loaded onto the aeroplane.

All of these measures have also meant that the time required to carry out the necessary examinations has increased, and that the costs for the air industry have risen. There is a need for the future to discover solutions that provide increased protection while at the same time give efficient handling of passenger traffic.

The discussion concerning issues with respect to air security has shown that increased protection is desirable with respect to all forms of loading and unloading aeroplanes.

The present invention offers a method that significantly increases security.

The present invention thus relates to a method for loading goods and passengers into an aeroplane, where every passenger is identified, and it is characterised in that goods at least comprising each piece of luggage that belongs to a passenger is provided with a transponder in which information bound to the identity of the passenger and, possibly, the destination of the luggage is stored, in that a communicator at the entrance of the aeroplane for luggage is caused to read the transponder on the luggage that is introduced into the aeroplane, in that a communicator at the relevant embarkation gate is caused to read the transponder on the relevant carry-on luggage in association with an electronic scanning of the passenger's ticket for boarding the aeroplane, in that the information read in each transponder is caused to be stored in a central database together with information from the scanned ticket, and in that the said information is compared by a computer connected to the said database, and in that in the case of a discrepancy in information an alarm is caused to be given.

The invention is described in more detail below, partially in connection with the attached drawing in which:

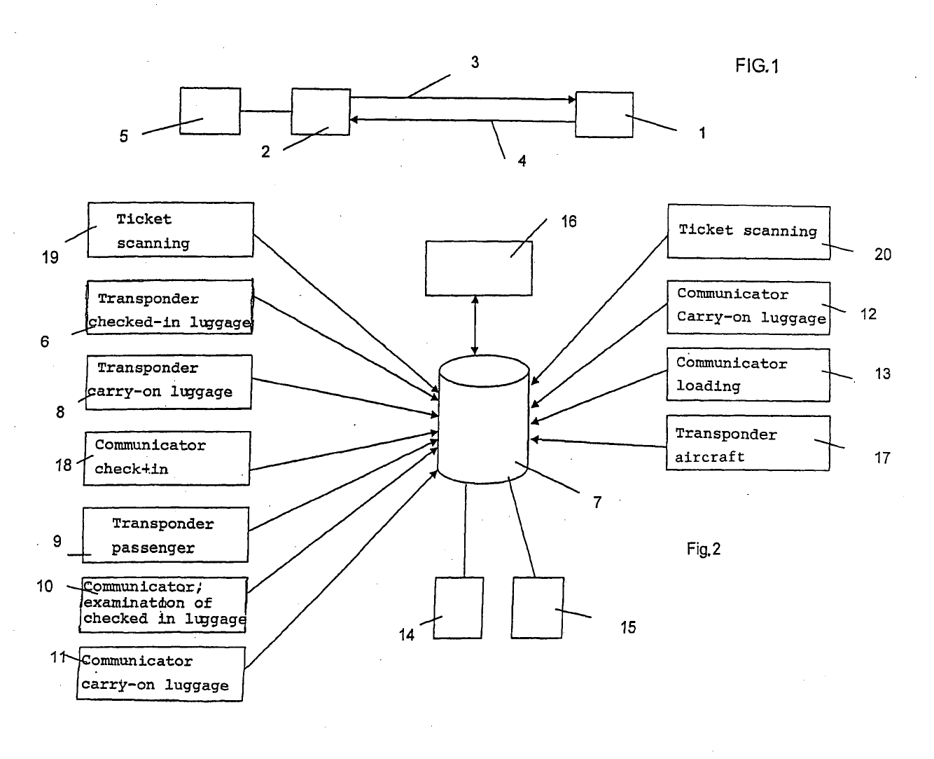

FIG. 1 shows schematically a communication system comprising a transponder and a communicator

FIG. 2 shows a block diagram that gives an example of the invention.

A method for loading goods and passengers into an aeroplane, in which each passenger is identified.

According to the invention, goods, at least comprising each piece of luggage belonging to a passenger, is equipped with a transponder in which information bound to the identity of the passenger and the destination of the luggage is stored.

It is appropriate that this takes place when the passenger checks in at a check-in desk in the departure hall of the airport. At this time the ticket is scanned with respect to, at least, the name of the passenger and flight information, such as destination. A first transponder is programmed and attached either to or placed into the checked-in luggage. A second transponder is programmed and attached to or placed into each piece of carry-on luggage. “Programming” is here taken to denote that the said information is stored in a memory in the relevant transponder by means of a communicator.

Known automatic identification systems that use radio frequencies, known as “RFID” (Radio Frequency Identification) systems, contain identification tags (ID-tags) and communicators. One known type of identification tag comprises an aerial, a modulator and a circuit for control logic in order to control the modulator. Such a known ID-tag is designed such that it is arranged to receive a signal transmitted from a communicator and to reflect this signal in modulated form.

The ID-tag is applied to the object or person that is to be identified. The identity can be read by a communicator at a certain short distance, for example, five metres. It is also possible, depending on the design, to read and write other information into the ID-tag with the aid of the communicator, in addition to an identity.

The relatively short range, five metres for example, makes it possible to communicate with the ID-tags within a geographically limited region of communication.

Such an RFID system is used according to one preferred embodiment of the present invention. However, another, equivalent system, such as a Bluetooth system, can be used instead in which transponders and communicators communicate using the technology known as Bluetooth.

Furthermore, a first communicator at the entrance of the aeroplane for luggage is, according to the invention, caused to read the said first transponder on the luggage that is loaded onto the aeroplane. The communicator may be located on the aeroplane or it may be located on the loading vehicle that transports luggage into the aeroplane.

A second communicator located at the relevant passenger embarkation gate is caused to read the said second transponder on the relevant carry-on luggage in association with an electronic scanning of the passenger's ticket for boarding the aeroplane.

According to one preferred embodiment of the invention, scanning of the ticket comprises scanning of the identity of the passenger while this is at the same time checked against an identity document.

Furthermore, the information read in each transponder is, according to the invention, caused to be stored in a central database together with the information from the scanned ticket.

The said information is compared by a computer connected to the said database. In the case of a discrepancy in the information an alarm is caused to be given.

Thus both checked-in luggage and carry-on luggage will, through the method, be registered as loaded onto the aeroplane and bound to a certain passenger, while at the same time the embarkation of the passenger is registered.

A communication unit for the identification of objects or persons is shown in FIG. 1. The communication unit comprises a transponder 1 and a communicator in the form of a receiver/transmitter unit 2. The communicator 2 is arranged to transmit a query signal 3 to the transponder 1. The transponder is arranged to receive the query signal and thereby reflect and modulate the query signal. The communicator 2 is arranged to receive the reflected signal 4 and to decode its information content. The communicator 2 is connected to a supervisory computer system 5 of a suitable type such as cable, radio, W-Lan, GSM/GPRS/G3 or similar.

FIG. 2 shows a block diagram that illustrates the present invention.

When a passenger checks in before a flight, a check is carried out either at a traditional check-in desk or in a check-in machine that the booking has been made. It is appropriate that in connection with the checking in a check is made against an identity document that the correct person is checking in.

The ticket is scanned by means of a known scanner 19. The information on the ticket is passed to a database 7.

At this time, any luggage that is to be checked in is delivered to a check-in desk. At this time, information is stored in the first transponder 6 at least concerning destination and information that provides the identity of the passenger. In addition to this, further information such as booking number, aeroplane identification, departure time, the home address and the temporary address of the passenger, etc., can be stored. The transponder provided with the information is attached to or placed into the checked-in luggage. Equivalent information is fed preferably into a transponder for each piece of carry-on luggage that the passenger has.

It is also possible to equip the passenger with a transponder 9 in which information about luggage, the ticket, the flight and identification has been stored.

Feeding in of information into each transponder takes place in association with the checking in of luggage by means of a communicator 18.

Alternatively, the said transponders may contain solely an ID number, and it may not be possible to program them with an ID number. In this case, the information about approval, destination, etc., is retrieved from a central database at the airport. In this case, the ID number of the transponder is fed into the last mentioned database together with other information. When the transponder is subsequently read by a communicator, the read ID number can thus be paired with the information desired.

Checked-in luggage is examined at most airports using, for example, X-rays, once the luggage has been transported to a luggage-handling region. Once the luggage has been examined and approved, information to this effect is stored by means of a communicator 10 at the examination location.

All carry-on luggage is examined using X-rays before the passenger gate. Once the luggage has been approved, storage to this effect takes place in the transponder of the carry-on luggage by means of a communicator 11.

The information that is stored in each transponder and the ticket information is transferred to a central database 7.

A communicator 11 can read the transponder of the carry-on luggage during examination of this luggage, and the identity of the passenger can be checked against the ticket or against a transponder 9 that the passenger carries. A coupling is made at this time between the identity of the individual and the identity of the ticket and of the luggage.

The central computer system has at this time information at least concerning which passengers have checked-in, flight information, the checked-in luggage and the carry-on luggage of the passengers, and confirmation that the luggage has been examined.

It is now possible to create an expectation value. Through a central computer system that is present at all airports, the so called FIDS system (Flight Information and Destination System), facts are obtained concerning, among other items, the gate at which the relevant aeroplane is waiting and when boarding is to take place. By pairing such information with the information from the database 7 about expected passengers and their luggage, it is expected which checked-in luggage is to be loaded, which passengers are to board the aeroplane and information about the carry-on luggage of the passengers.

As the passengers pass through the gate, the transponder 8 of the carry-on luggage of the passengers are read by means of a communicator 12. The passengers' tickets are scanned by means of a known scanner 20. If the passengers carry transponders 9, these are also read. Ticket information and the information in the transponders is transferred to the database 7.

Checked-in luggage is loaded into the aeroplane. The transponders of the luggage are read during loading and the information is transferred to the database 7.

The aeroplane can be identified during loading through the aeroplane having been equipped with a transponder 17 that is read by the communicator 13 at the loading entrance of the aeroplane, whereby this information is transferred to the database 7.

It is thus preferred that, in the case in which the said communicator at the entrance to the aeroplane is independent of the aeroplane, the aeroplane is equipped with a transponder that is caused to be read by the said communicator or another communicator, whereafter the information read is transferred to the said database.

As has been mentioned above, the said information is compared by a computer 16 connected to the said database 7. In the case of a discrepancy in the information an alarm is caused to be given by means of an appropriate alarm means 14, 15.

One discrepancy may be that luggage has not been approved, that a passenger that passes the gate has more or fewer items of luggage than the number checked-in and/or examined, that the passenger is not the one who has checked in, that luggage has been loaded onto the wrong aeroplane, etc.

According to one preferred embodiment, the said alarm is given at at least one location and that at this location the discrepancy is displayed on a display such that security personnel can take a decision concerning what measures are to be taken.

According to one highly preferred design, an alarm is given at at least two different locations located at a large distance from each other in order to make manipulation of the alarm means more difficult.

It is in this case preferred that the alarm means is located in the control tower of the airport. This ensures that an aeroplane does not receive permission to take-off if the system has discovered a discrepancy in the information of the types described above.

This system, finally, will offer reports in order to be able to follow and to document the events that have taken place. This means that the events, at least to a certain extent, can be reconstructed in the case for which a passenger has attempted to circumvent currently valid routines.

By identifying and verifying information against a central database with relevant information, or with interacting and co-ordinated databases, a secure real-time adapted check is obtained. Advantages include increased security, increased efficiency and automatic documentation of all events. A system is in this way created that shows high performance and high flexibility at a reasonable cost, since many of the components that are needed are already available in use.

A number of embodiments have been described above. It is, however, clear that the routines described can be changed without deviating from the invention.

The present invention is, for this reason, not to be considered as limited to the embodiments described above, since variations can be made within the scope of the accompanying claims.

1. A method for loading goods and passengers into an aircraft, in which every passenger is identified, wherein goods at least including each piece of luggage that belongs to a passenger is equipped with a transponder in which information associated with the identity of the passenger and the destination of the luggage is stored, wherein a communicator at the a luggage entrance of the aircraft reads information from the transponder on the luggage that is loaded into the aircraft, and wherein a communicator at a departure gate for passenger embarkation reads the transponder on carry-on luggage, said method comprising the steps of: reading of transponders at the departure gate is coupled with an electronic scanning of a passenger's ticket for boarding the aircraft; storing the information read from each transponder in a central database together with information from the scanned ticket; comparing the read information with previously stored information in a computer connected to the central database; and providing an alarm in the case of a discrepancy in the compared information.

2. A method according to claim 1, including the steps of: providing an alarm at at least one location; and displaying a discrepancy on a display in order to allow security personnel to determine what measures should be taken.

3. A method according to claim 2, wherein the alarm is given at at least two different locations.

4. A method according to claim 1, wherein the transponder is an RFID-transponder.

5. A method according to claim 1, wherein a transponder on luggage includes information that the luggage has been examined and approved for loading on the aircraft.

6. A method according to claim 1, wherein when the communicator at the luggage entrance of the aircraft is independent of the aircraft, the aircraft includes a transponder that is read by a communicator, after which the information that is read is transmitted to the central database.
